(19) United States
(12) Patent Application Publication
(10) Pub. No.: US 2004/0257236 A1
(43) Pub. Date: Dec. 23, 2004

(54) Detector system

(76) Inventor: David Klemish, Midland, MI (US)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/887,604

(22) Filed: Jul. 9, 2004

Related U.S. Application Data
(63) Continuation-in-part of application No. 10/269,242, filed on Oct. 11, 2002.

(51) Int. Cl. G08B 17/10

(52) U.S. Cl. 340/628; 340/693.2

(57) ABSTRACT

A detector system that utilizes a remote backup power source to provide backup power to a plurality of detectors. The detector system is configured so that if the primary power source, typically a commercially available 110V power source, to one or more of the detectors is cut, the remote backup power source will provide power to those detector(s) lacking power. The remote backup power source can be a rechargeable battery and can be strategically placed in a residence, such as in a utility room or garage, so as to make the battery readily accessible to the residence's occupant(s).

This application is a continuation-in-part of U.S. patent application filed Oct. 11, 2002 as Ser. No. 10/269,242, from which priority is claimed.

### FIELD OF THE INVENTION

The present invention generally relates to detector systems, such as smoke detector systems. More specifically, the present invention relates to a detector system comprising multiple detectors connected to a single backup power source, such as a battery.

### BACKGROUND OF THE INVENTION

The use of detectors, such as smoke detectors, is known in the art. The International Building Code (“IBC”) currently imposes a number of requirements on all smoke detectors built into new residential dwellings. According to the IBC, all residential smoke detectors must be connected to a commercial power source, for example, a 110V power source, and must have a battery backup in case the commercial power source is disconnected. Additionally, the IBC requires that all smoke detectors in a system ring if any of the detectors detects smoke.

Unlike other detectors, in current commercial smoke detector systems, each smoke detector in the system has provided in it, an individual battery as a backup power source. That is, if there are eight detectors in the system, then there will be eight different batteries used as backup power sources in the system. These batteries are typically 9V batteries that are readily available commercially. However, commercial detector systems suffer from a number of disadvantages. The backup batteries typically must be replaced every 6 to 12 months. If the backup batteries are not replaced, a detector will emit a periodic beeping sound to alert the home occupant that its backup battery charge is getting low. The periodic beeping will continue until the battery charge is too low, at which time the beeping will cease. Typically, the periodic beeping that indicates a low battery charge will last about 1 to 2 weeks until the backup battery charge is virtually non existent (i.e., the backup battery is completely dead). If a home occupant happens to be out of the dwelling during the 1 to 2 weeks the detector is beeping, such as would happen if the home occupant is on vacation, the home occupant would not be alerted to the dead backup battery. Consequently, the backup battery may not get replaced for quite some time, making the dwelling less safe.

Additionally, smoke detectors are typically placed in places that are difficult to reach, such as the peak of a vaulted ceiling, making replacement of the backup battery difficult, especially for elderly individuals or individuals that are physically handicapped.

### SUMMARY OF THE INVENTION

The present invention addresses the issues presented above by providing a detector system that utilizes a remote backup power source to provide backup power to smoke detectors. Detector systems of the present invention are generally powered by a primary power source, typically a commercially available 110V power source. The detector system is configured so that if the primary power source to one or more of the detectors is cut, the remote backup power source will provide power to those detector(s) lacking power. In a preferred embodiment, the remote backup power source is a battery. The remote backup battery is strategically placed in a residence so as to make the battery readily accessible to the residence's occupant(s), generally, in a garage, basement, storage room, or the like, wherein the control of the battery and its accessibility can be by a person without the use of ladders, scaffolding, or the like. What is meant by “remote”, or “remotely”, in this invention is that the backup battery is dislocated from the individual smoke detectors, and is readily accessible to a person without the use of ladders, scaffolding, or the like. Such “dislocation”, would be in a garage, basement, storage, room, utility room, or the like.

### THE INVENTION

What is claimed herein as the first embodiment of the invention is a smoke detector system, comprising at least one smoke detector. Each such smoke detector is electrically connected to a primary power source, and each such smoke detector is adapted to detect one or more conditions and to activate by emitting a warning signal when one or more of the conditions is detected. There is a backup battery, the back up battery being remotely dislocated from, and being hard-wired directly to, all such smoke detectors. In addition, there is a monitoring circuitry capable of electrically connecting the backup battery to any detector that becomes electrically disconnected from the primary power source.

In a second embodiment, the remote backup battery is a rechargeable battery. In a third embodiment, the rechargeable battery is connected to a trickle charge so that the rechargeable battery is continuously being charged whenever the detector system is connected to the primary power source. In a fourth embodiment, each detector has a corresponding indicator that indicates whether the detector is being powered by the primary power source or whether the detector is being powered by the backup power source. In a fifth embodiment, the detectors can all be tested simultaneously. In a sixth embodiment, the detector system of the present invention is configured so that if a single detector is activated due to detection of smoke, all detectors sound to alert any residential occupants.

### DESCRIPTION OF THE DRAWINGS

The present invention is illustrated by way of example in the following drawings in which like references indicate like elements. The following drawings disclose various embodiments of the present invention for purposes of illustration only and are not intended to limit the scope of the invention.

FIG. 1 illustrates a schematic for one example of a detector system according to the present invention.

FIG. 2 illustrates a schematic of monitoring circuitry useful in embodiments of the present invention.

FIG. 3 illustrates a schematic of detector circuitry useful in embodiments of the present invention.

FIG. 4 illustrates a schematic of one example of circuitry that monitors the charge level of the backup battery in embodiments of the present invention.

FIG. 5 illustrates a schematic of circuitry for generating a test signal in embodiments of the present invention.

### DETAILED DESCRIPTION OF THE INVENTION

In the following detailed description of the present invention, reference is made to the accompanying drawings, which form a part hereof, and in which are shown by way of illustration specific embodiments in which the present invention may be practiced. It should be understood that other embodiments may be utilized and structural changes may be made without departing from the scope of the present invention.

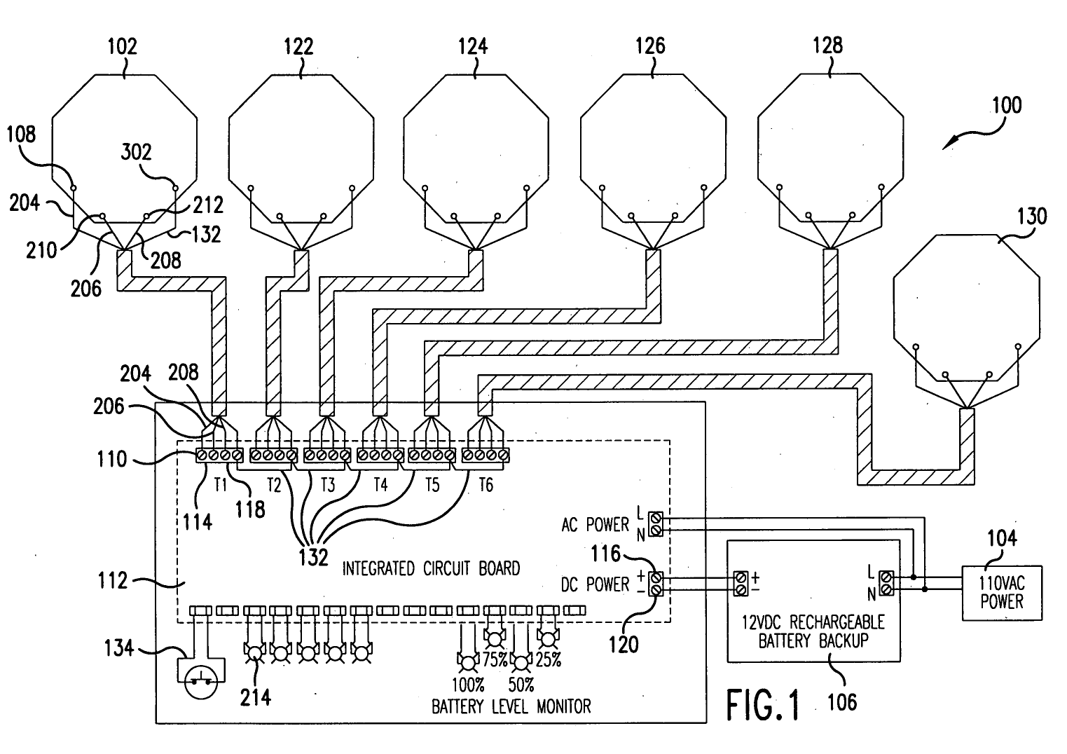

An example of a detector system according to the present invention is illustrated in FIG. 1. Detector system 100 comprises a plurality of individual detectors 102. Each detector 102 is adapted to detect smoke and to activate by emitting a warning signal (for example, a loud sound) when one or more of the conditions is detected. Detectors known in the art can be readily adapted for use in the present invention by those of ordinary skill in the electrical arts. The detectors 102 do not all have to be identical.

Detector systems of the present invention are connected to a first or primary electrical power source and a second or backup electrical power source. In normal operation, detector systems of the present invention are powered by the primary power source. Detector systems of the present invention are designed so that if the primary power source is lost, power is switched to the backup power source. Most commonly, the primary power source is a commercially available AC power source such as is generally provided to residential dwellings. The backup power source is commonly a DC power source as a backup battery.

In FIG. 1, the detector system 100, including detectors 102, is electrically connected to a primary power source 104, which in FIG. 1 is an 110V power source. The detector system 100, including detectors 102 is electrically connected to a backup power source 106, which in FIG. 1 is a 12V backup battery. The voltage of the backup battery may vary depending on the application. For example, a 12V battery will supply sufficient power for most residential detector systems. In some applications a 9V battery will supply sufficient power. However, it is within the scope of the present invention that higher voltage batteries can be advantageously utilized in detector systems of the present invention.

In a preferred embodiment, the backup power source in detector systems of the present invention will be a rechargeable battery connected to a trickle charge. A trickle charge is known in the electrical arts and allows the rechargeable backup battery to be continuously recharged whenever the present detector system is powered by the primary power source. Whenever the primary source is lost, the backup battery will power the plurality of detectors until the primary power source is restored at which time the backup battery will be recharged. It should be noted that commercial rechargeable batteries have a significantly longer life span than non rechargeable batteries. A typical 12V rechargeable battery may last up to approximately 20 years.

In detector systems of the present invention, multiple detectors can be connected to a single, remote backup power source. In a preferred embodiment, the detector system utilizes a single, remote backup battery to power the detector system, including all the individual detectors, whenever power from the primary power source is lost. Detectors in systems of the present invention are electrically connected to power source monitoring circuitry. The power source monitoring circuitry of the present invention is designed to detect when the primary power source has been disconnected or otherwise lost. The power source monitoring circuitry of the present invention is further designed to electrically switch the detector to the backup power source, typically a DC power source such as a backup battery, whenever the circuitry detects that the primary power source has been disconnected from the detector.

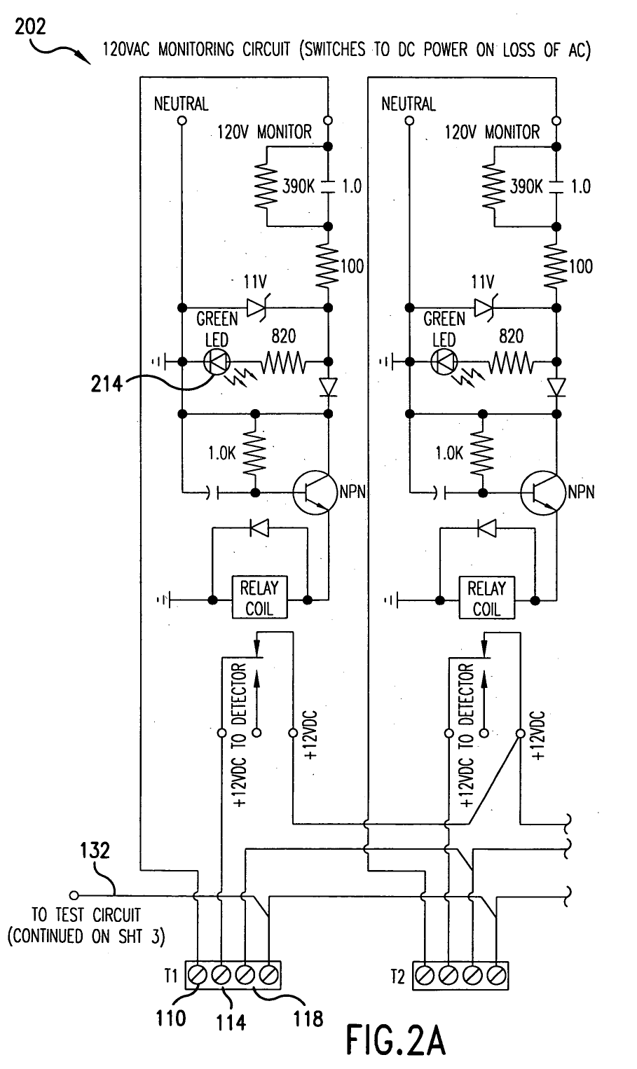

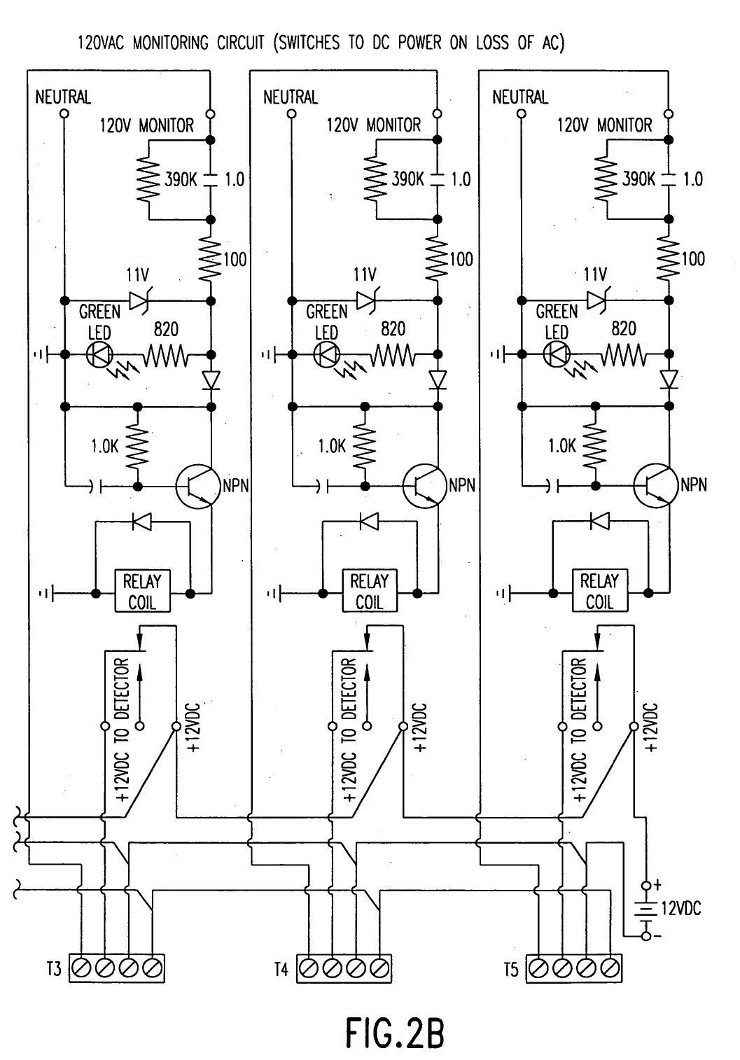

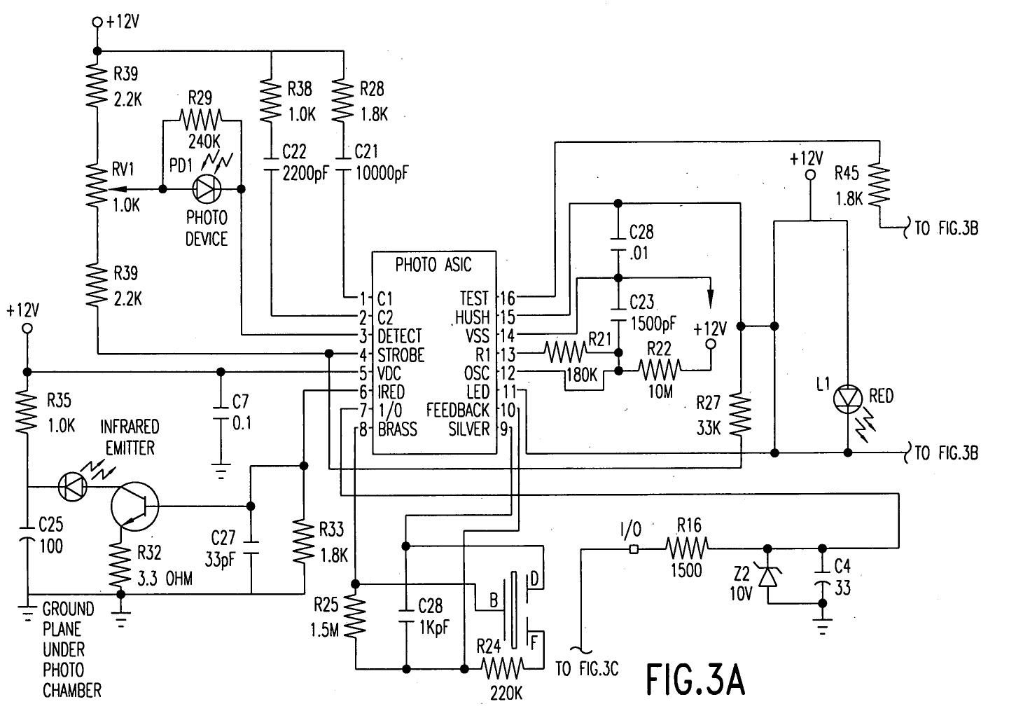

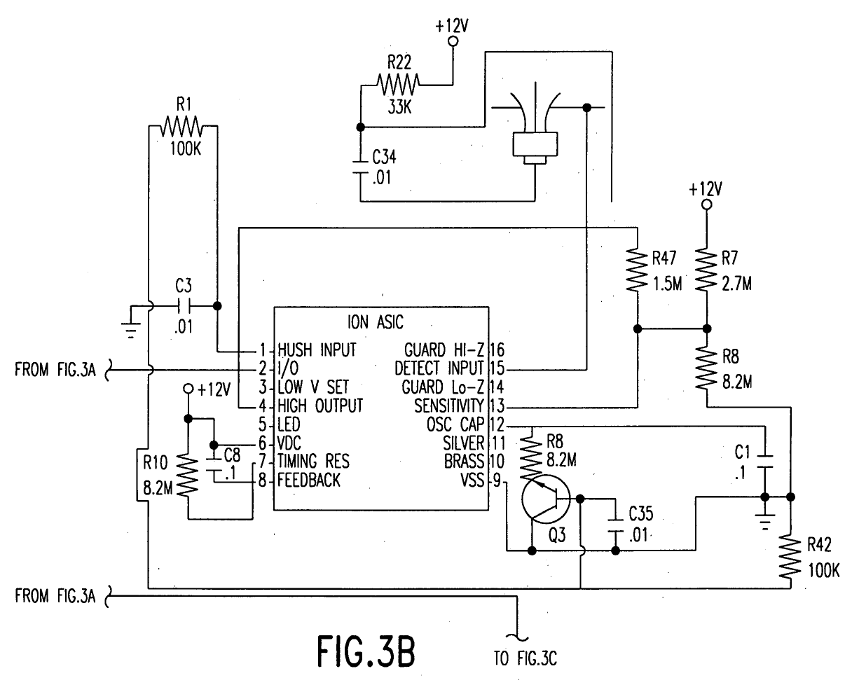

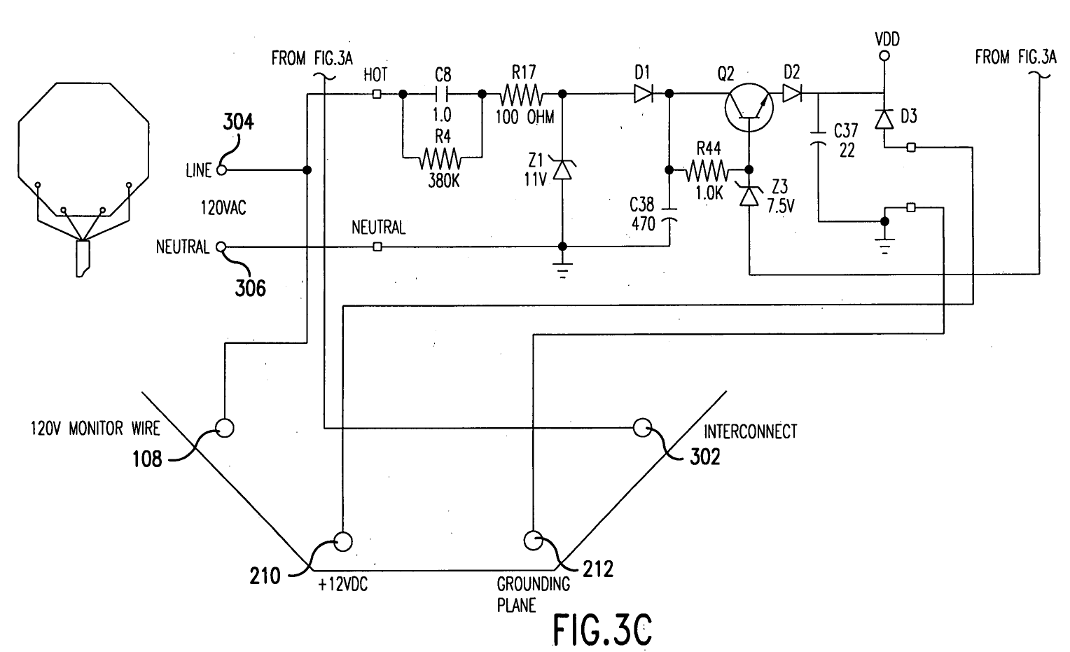

FIG. 2 illustrates an example of a power source monitoring circuit 202 according to the present invention. Monitoring wire 204 connects monitoring circuit 202 to detector 102 at point 108 on detector 102 and at point 110 on terminal T1. As shown in FIG. 2, monitoring circuit 202 is also connected to point 110 on terminal T1. As demonstrated in FIG. 3, each detector 102 is designed so that monitoring line 204 has power whenever the detector 102 has power via the primary power source. Typically, monitoring line 204 will be an 110V line. Monitoring circuit 202 is connected to detector 102 via line 206 at contact 210 on detector 102 and contact 114 on terminal T1.

Monitoring circuit 202 is also connected to detector 102 via ground line 208 at contact 212 on detector 102 and at contact 118 on terminal T1. Circuit board 112 connects monitoring circuit 202 to the backup power source 106 by connecting contact 114 on terminal T1 to contact 116. Circuit board 112 also connects monitoring circuit 202 to the backup power source 106 by connecting contact 118 on terminal T1 to contact 120. Detectors 122,124,126,128, and 130 are similarly all connected to backup power source 106 via a monitoring circuit.

The monitoring circuit 202 performs as a switch. Whenever power is available via monitoring line 204, the switch is open and no power is supplied from the backup power source 106 to the detector 102. However, whenever there is a loss of power on monitoring line 204, monitoring circuit 202 detects the loss of power and closes the switch, supplying detector 202 with power from the backup power source 106 via lines 206 and 208.

Similarly, if a monitoring circuit connected to detectors 122,124,126,128, or 130 detects a loss of power, it will supply power from backup power source 106 to the corresponding detector.

Monitoring circuits in preferred embodiments of the present invention comprises indicators to indicate whether the corresponding detector is receiving power from the primary power source. For example, a monitoring circuit may comprise an LED that lights whenever power is available via the monitoring line and does not light whenever there is a loss of power on the monitoring line. In this manner, an individual (a residential occupant, for example) can quickly see which detectors, if any, are not getting power from the primary power source. The use and advantage of monitoring circuit indicators is illustrated in FIGS. 1 and 2. Monitoring circuit 202 comprises LED indicator 214. Whenever monitoring circuit 202 detects power from the primary power source on monitoring line 204 via contact 110, the LED indicator 214 light will be on. Whenever monitoring circuit 202 detects a loss of power from the primary power source on monitoring line 204 via contact 110, the LED indicator 214 light will be off.

As demonstrated in FIG. 1 the LED indicators can all be placed in a single, easily visible location such as on the circuit board 112. Thus, an individual can quickly observe which detectors are receiving power from the primary power source by observing which LED indicators are lit.

FIG. 3 illustrates a schematic of detector circuitry useful in detector systems of the present invention. FIG. 3 illustrates how the circuitry is connected to contacts 108,210, 212, and 302. Contact 304 is connected to the hot line of the primary power source 104 and contact 306 is connected to the neutral line of the primary power source 104. Any detector in detector systems of the present invention may be connected to any circuit of the primary power source 104. Other circuitry known to those of ordinary skill in the art of detectors can also be advantageously utilized in detectors useful in embodiments of the present invention.

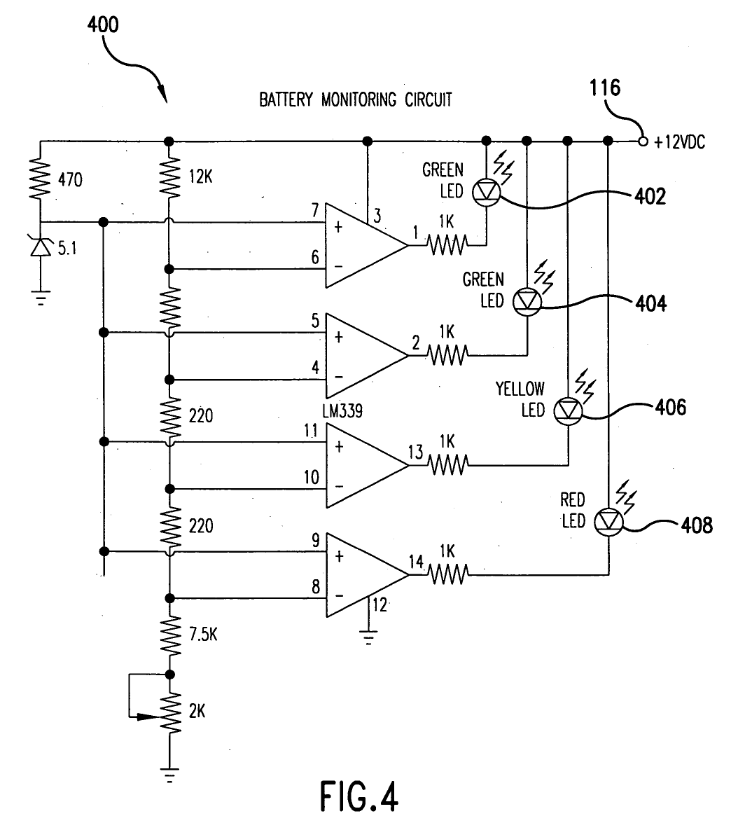

Preferred embodiments of the present invention additionally comprise circuitry that monitors the charge level in the backup power source. FIG. 4 illustrates circuitry 400 that uses four LEDs to indicate the approximate percentage of charge remaining in a 12V battery, such as the backup power source 106 shown in FIG. 1. The first LED 402 indicates that approximately 100 percent of the charge is available; the second LED 404 indicates that approximately 75 percent of the charge is available; the third LED 406 indicates that approximately 50 percent of the charge is available; and the fourth LED 408 indicates that approximately 25 percent of the charge is available. When the backup power supply is a battery, circuitry 400 is helpful for informing a residential occupant, for example, when the battery should be replaced.

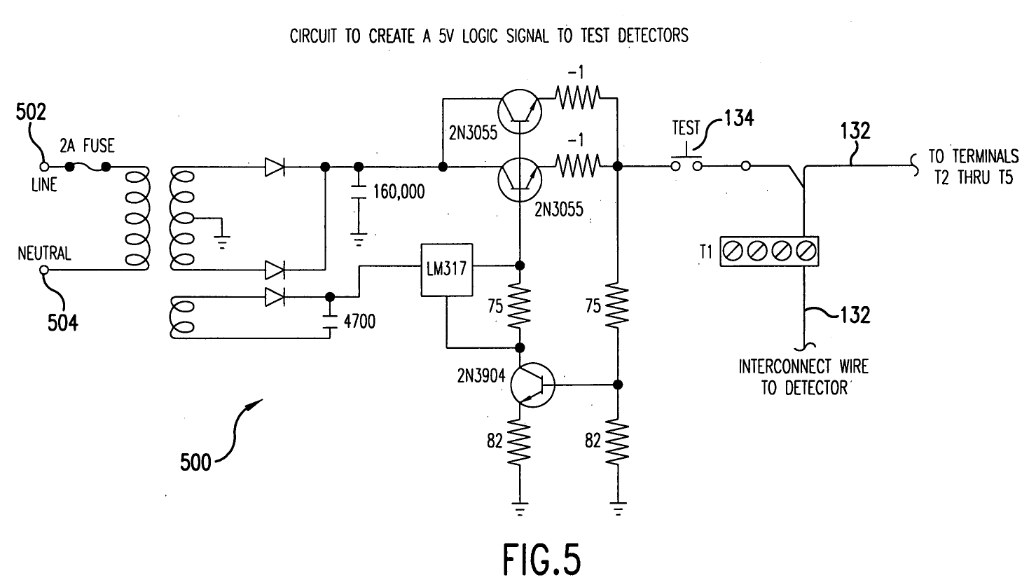

Preferred embodiments of the present invention also comprise testing circuitry that can be advantageously utilized to simultaneously test all detectors. FIG. 5 illustrates testing circuitry 500 that can be advantageously utilized in embodiments of the present invention. Testing circuitry 500 is connecting to the primary power source via line 502 and neutral line 504. Testing circuitry 500 is also connected to all detectors via interconnect line 132. By way of example, interconnect line 132 is connected to detector 102 at interconnect contact 302. The interconnect line 132 is similarly connected to other detectors at their corresponding interconnect contacts. When button 134 is depressed a 5V signal is sent to all detectors via interconnect line 132. Each detector connected to interconnect line 132 is designed to be activated whenever a 5V signal is received at the detector's interconnect contact. The signal sent over the interconnect line to test the detectors can be any voltage so long as the detectors are designed to recognize the signal when sent to the interconnect contact via the interconnect line. In this manner, all detectors in the detector systems of the present invention can be simultaneously tested by depressing a single button. That is, any detector that does not activate when the button is depressed should be checked.

In preferred embodiments of the present invention, detectors are designed such that whenever a detector is activated it will send a signal over the interconnect line to activate the other detectors. In this manner, whenever a single detector detects a smoke condition all the detectors in the detector system will be activated.

While the present invention has been described in detail with respect to specific embodiments thereof, it will be appreciated that those skilled in the art, upon attaining an understanding of the foregoing, may readily conceive of alterations to, variations of and equivalents to these embodiments. Accordingly, the scope of the present invention should be assessed as that of the appended claims and ay equivalents thereto.

What is claimed is:

1. A smoke detector system, comprising:
at least one smoke detector, wherein each such smoke detector is electrically connected to a primary power source, and each such smoke detector being adapted to detect one or more conditions and to activate by emitting a warning signal when one or more of the conditions is detected;
a backup battery, said back up battery being remotely dislocated from, and being hard-wired directly to, all such smoke detectors, and
a monitoring circuitry capable of electrically connecting the backup battery to any detector that becomes electrically disconnected from the primary power source.

2. The detector system of claim 1, wherein the primary power source is an AC power source.

3. The detector system of claim 1, wherein the battery is a rechargeable battery.

4. The detector system of claim 3, wherein the rechargeable backup battery is electrically connected to a trickle charge.

5. The detector system of claim 1, wherein there is a plurality of detectors and the plurality of detectors are configured so that when one or more detectors is activated by detecting one or more conditions, all detectors are activated.

6. The detector system of claim 1, further comprising testing circuitry that allows all of the detectors to be tested simultaneously from a remote location.
